(19) United States
(12) Patent Application Publication
(10) Pub. No.: US 2008/0195468 A1
(43) Pub. Date: Aug. 14, 2008

(54) Rule-Based Contiguous Selection and Insertion of Advertising

(76) Inventor: Dale Malik, Atlanta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/609,004

(22) Filed: Dec. 11, 2006

(51) Int. Cl. G06Q 30/00

(52) U.S. Cl. 705/14

(57) ABSTRACT

Streaming content is combined with advertising using an ad selection and insertion application. Content information, ad information, and user information may all be used to select ads for incorporation into the streaming content, whether audio and/or video. Ad information may include demographic targets for an ad, as well as information about series of ads. Ad selections may be personalized for users based on viewing history and user preferences. Once an ad is played, information may be sent back to an ad service provider for tracking purposes.

### CROSS-REFERENCE TO RELATED APPLICATIONS

This application is related to the co-pending U.S. application having Ser. No. ______, entitled “Media Content Alteration,” filed on ______, and having Attorney Docket No. 60027.5027US01/BLS 060210.

### TECHNICAL FIELD

This application relates generally to advertising. More particularly, this application relates to personalized ad selection for presentation in conjunction with streaming content.

### BACKGROUND

Television, radio, and other broadcast advertisers have a difficult job in trying to target an ad to the right content consumer. These advertisers must rely on demographic surveys and/or estimates to select networks, programs and/or geographic markets to run their ads. Although they can reach a select audience using these methods, it is still an inexact science, and only some portion of the actual audience may be the intended target of the ad. Even intended targets of ads may not be ideal, and entirely ignored targets may be lost because they did not happen to be watching or listening to the selected program at the right time.

In addition, the growing popularity of digital video recorders (DVRs) and other digital recording devices has made the job of broadcast advertisers all the more difficult. With DVRs and MP3 players, a content consumer (i.e., one who watches or listens to content) will frequently fast forward through advertising, especially if the advertising is uninteresting or irrelevant to the content consumer. Also, because of the content consumer's ability to time-shift a program by recording and playing it at a later date, advertisements which are time-sensitive (e.g., a one-day sale at a retailer) may be outdated once the program is played. Content consumers are also able to place-shift their media-consumption using place-shifting devices such as Sling Media's SLINGBOX. Using such devices, a content consumer can take a program that was originally recorded at home and stream it over a network connection to a remote location, potentially in another state or country. Because of place-shifting, geography-specific ads (e.g., a car dealer ad) may be irrelevant to the content consumer viewing the ad in a distant location.

To combat the tendency of consumers to skip ads, advertisers have innovated with respect to ad content. For example, advertisers have attempted to make the ads as interesting to watch and/or hear as the programs themselves. One way of making ads more watchable has been to create episodic ads, or create a series of ads with a continuing story line. Content consumers may feel compelled to watch or listen to a subsequent ad episode if they had seen or heard a previous ad in a series and wanted to know what happens next. However, it is difficult on the part of advertisers to determine which content consumers have seen which episodes in a series of ads, and content consumers may miss key episodes and lose interest. Ultimately, the goal is to create advertising which is compelling and is delivered at the right time and place so that the product or message is relevant to and ingrained in the minds of targeted content consumers.

Under the current broadcast advertising paradigm, no matter how successfully targeted an ad may be, it is difficult for an advertiser to tell how many and who viewed or heard their ad. Television, radios, and other media devices provide little or no feedback. Broadcast advertising is ultimately a gamble based on demographic statistics and guessing.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one or more embodiments described herein, methods and systems provide for selecting advertisements for incorporation into a content stream. The content stream is received, along with content information associated with the content stream. Ad information associated with a collection of advertisements is also received. The ad and content information are utilized to select a subset of advertisements for incorporation into the content stream.

According to another embodiment of the invention, a method provides for selecting a personalized set of advertisements for incorporation into a video program. A software application receives a request to view the video program and receives the program along with information about available advertisement slots in the video program. Information about a plurality of advertisements is retrieved, along with information about a user. The advertising information is used in conjunction with the user information to select the set of advertisements to fill the available advertisement slots.

Other systems, methods, and/or computer program products according to embodiments will be or become apparent to one with skill in the art upon review of the following drawings and Detailed Description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating an example of a computing device in which embodiments may be implemented;

FIG. 2 depicts an example of an ad selection and insertion system according to one or more embodiments;

FIG. 3 is a block diagram depicting inputs and outputs of an ad selection and insertion application according to one or more embodiments;

FIG. 4 is a block diagram depicting operation of the ad selection and insertion application according to one or more embodiments;

FIG. 5 depicts a program timeline for streaming content according to one or more embodiments;

FIG. 6 depicts an ad tray and a collection of stored ads for incorporation into streaming content according to one or more embodiments;

FIGS. 7A-7D depict program timelines for streaming content having incorporated advertisements according to one or more embodiments; and

FIG. 8 is a flowchart depicting a process for selecting personalized ads and incorporating them into streaming content.

### DETAILED DESCRIPTION

The following detailed description is directed to methods and systems for selecting customized ads for presentation in conjunction with streaming content. In the following detailed description, references are made to the accompanying drawings that form a part hereof, and which are shown, by way of illustration, using specific embodiments or examples. Referring now to the drawings, in which like numerals represent like elements through the several figures, aspects of the methods and systems provided herein will be described.

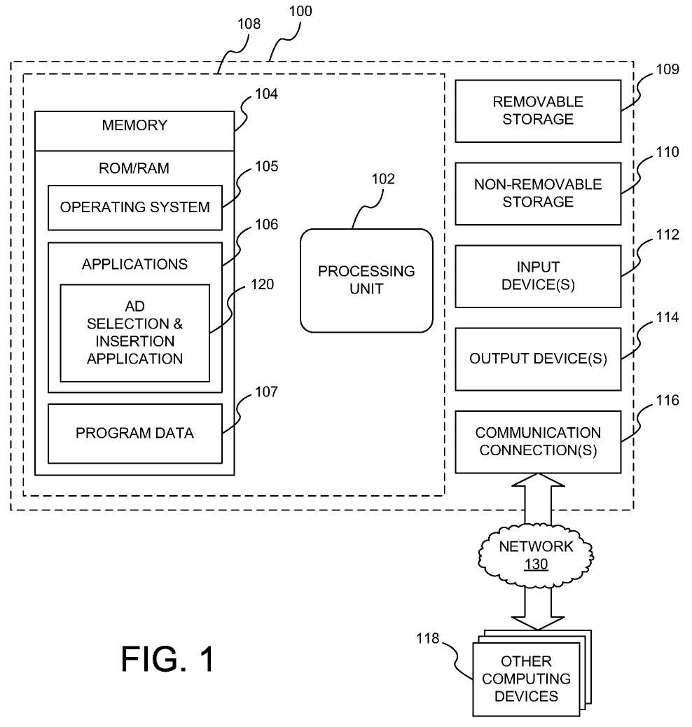

FIG. 1 and the following discussion are intended to provide a brief, general description of a suitable computing environment in which embodiments of the invention may be implemented. While embodiments of the invention will be described in the general context of program modules that execute in conjunction with an application program that runs on an operating system on a computer system, those skilled in the art will recognize that other embodiments of the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including embodiments of the hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a network. In a distributed computing environment, program modules may be located in both local and remote memory storage devices.

With reference to FIG. 1, embodiments of the invention may include a computing device, such as the computing device 100. In a basic configuration shown in FIG. 1, the computing device 100 includes at least one processing unit 102 and a memory 104. Multiple processors may accompany the processing unit 102. Depending on the configuration of the computing device 100, the memory 104 may be volatile (e.g., Random Access Memory (RAM)), non-volatile (e.g., Read-Only Memory (ROM), flash memory), or some combination thereof. The memory 104 serves as a storage location for an operating system 105, one or more applications 106, and may include program data 107, as well as other programs. In various embodiments, the applications 106 include an ad selection and insertion application 120, an application including similar logic, or any other set of instructions comprising such logic. It should be noted that the logic of the ad selection and insertion application 120 may be distributed and/or shared across multiple computing devices. More information regarding the function of the ad selection and insertion application 120 is provided below.

The computing device 100 may include additional features and functionality other than the features shown within dashed-line box 108. For example, the computing device 100 may include additional data storage components, including both removable storage 109 (e.g., floppy disks, memory cards, compact disc (CD) ROMs, digital video discs (DVDs), external hard drives, universal serial bus (USB) drives) and non-removable storage 110 (e.g., magnetic hard drives).

Computer storage media may include media implemented in any method or technology for storage of information, including computer readable instructions, data structures, program modules, or other data. The memory 104, the removable storage 109, and the non-removable storage 110 are all examples of computer storage media. Further examples of computer storage media include RAM, ROM, electrically-erasable programmable ROM (EEPROM), flash memory, CD-ROM, DVD, cassettes, magnetic tape, and magnetic disks. Any such computer storage media may be accessed by components which are a part of the computing device 100, or which are external to the computing device 100 and connected via a communications link (e.g., Bluetooth®, USB, parallel, serial, infrared). The computing device 100 may also include one or more input devices 112 for accepting user input. Examples of the input devices 112 include a keyboard, mouse, digitizing pen, microphone, touchpad, touch-display, and combinations thereof. Similarly, the computing device 100 may include output devices 114 such as displays, speakers, printers, and combinations thereof. It should be understood that the computing device 100 may also include additional forms of storage, input, and output devices. The input devices 112 and the output devices 114 may include communication ports and associated hardware for communicating with external input and output devices rather than including the devices with the computing device 100.

Computing device 100 includes one or more communication connections 116 that include hardware and/or software which enable the computing device 100 to communicate with other communications or computing devices 118 over a network 130. The network 130 may include a wireless network such as, but not limited to, a Wireless Local Area Network (WLAN) such as a WiFi network, a Wireless Wide Area Network (WWAN), a Wireless Personal Area Network (WPAN) such as Bluetooth®, a Wireless Metropolitan Area Network (WMAN) such as a WiMAX network, a cellular network, or a satellite network. Alternatively, the network 104 may be a wired network such as, but not limited to, a wired Wide Area Network (WAN), a wired (Local Area Network) LAN such as the Ethernet, a wired Personal Area Network (PAN), or a wired Metropolitan Area Network (MAN). Communication media, in the form of computer readable instructions, data structures, program modules, or other data in a modulated data signal, may be shared with and by the computing device 100 via the communication connection 116. Modulated data signal may mean a signal that has one or more of its characteristics set or changed in such a manner as to encode information in the signal, and may include a modulated carrier wave or other transport mechanism.

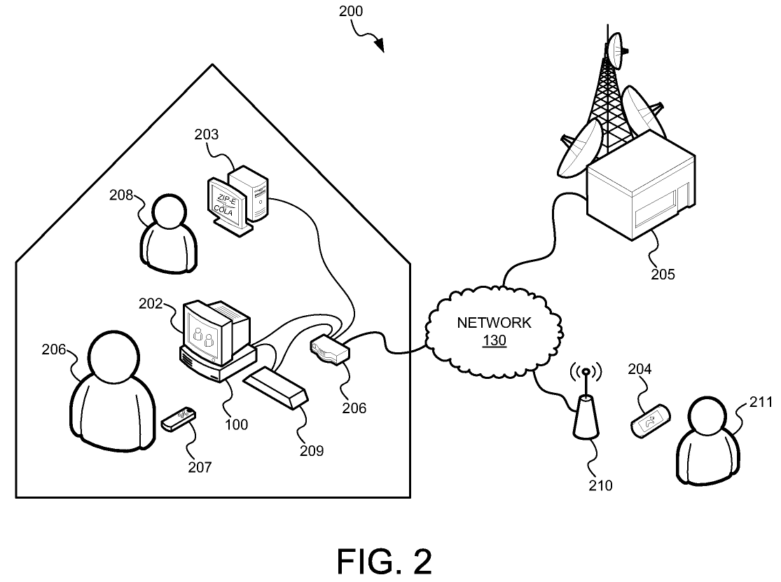

Turning now to FIG. 2, an ad selection and insertion system 200 according to one or more embodiments will be described. In the embodiment of FIG. 2, the ad selection and insertion system 200 enables the personalized insertion of ads into content streams by the computing device 100 for playback on one or more content playing devices 202, 203, 204. Although depicted as a single set top box in FIG. 2, it should be appreciated that the computing device 100 may be comprised of one or more computing devices working either independently or in concert with each other. The computing device 100 is connected to the network 130 via a network device 206 such as a router or a modem, via either a wired or wireless connection. The network 130 may include one or more open or closed networks, including a telecommunications network, a cable television network, the Internet, an Internet Protocol Television (IPTV) network, or any network for transmitting and distributing streaming content and/or data communications. Streaming content may include video programs, audio programs, podcasts, and other forms of streaming information. The network 130 may also include additional transmission, reception, and/or concentration points, including satellite receivers, modulators, routers, concentrators, multiplexers, and gateways.

Streaming content may be supplied through the network 130 by a source facility 205. Examples of source facilities 205 include cable head-ends, central offices, television and radio studios, television and radio network affiliates, video or sound production studios, cellular facilities, satellite receivers, and other facilities capable of generating and/or relaying streaming content via the network 130. Streaming content may additionally be supplied via local storage and/or hardware, including hard drives, compact discs (CDs), digital video discs (DVDs), webcams, microphones, and other local sources of streaming content. Streaming content in the embodiment of FIG. 2 is primarily streaming video content, but may, in other embodiments, include other forms of streaming content.

The computing device 100 may be a cable set top box, a digital video recorder (DVR), a “smart” television, an audio player, or any other device having a processing unit, such as the processing unit 102, and memory, such as the memory 104. In the embodiment of FIG. 2, the computing device 100 is a set top box with a DVR which receives streaming content via the network 130. The computing device 100 then selects and incorporates personalized advertising into the streaming content, and delivers the modified streaming content for playback on one or more content playing devices 202, 203, 204. According to the embodiment of FIG. 2, the content playing devices 202, 203, 204 include a television 202, a computer 203, and a portable media player 204. Content playing devices may also include, but are not limited to, radios, audio players, satellite audio receivers, personal digital assistants (PDAs), smartphones, and other devices capable of playing or otherwise consuming streaming content.

Streaming content played on the television 202 is selected by a user 206 using a remote 207. Streaming content displayed on the television 202 may include a standard program, such as an hour long drama. In the embodiment of FIG. 2, streaming content may also include live programming such as a sporting event or a program recorded locally on the computing device 100, or on other local devices. Streaming content played on the computer 203 may be selected by a user 208, or be selected by another person, such as a parent. The computing device 100 may use information about the streaming content selected for the television 202 and the computer 203, and/or information about the users 206, 208 to select advertising which is then incorporated into the program, as will be further discussed below.

The embodiment of FIG. 2 also includes a remote playback device 209, which may be a Sling Media SLINGBOX. Devices connected to the remote playback device 209 may send programming to users outside the home or business where the devices are located, using the network 130 to send the information. For example, programs stored using DVR functionality of the computing device 100 may be sent via the remote playback device 209 to the portable media player 204 for viewing by a user 211. The portable media player may be connected to the network 130 via a wireless access point 210. The computing device 100 may consider the remote location of the user 211 when selecting advertising for programs sent to the portable media player 204, as will be further discussed below.

Other embodiments of the ad selection and insertion system 200 may not use a separate computing device 100. Instead, the content playing devices 202, 203, 204 themselves may be embodiments of the computing device 100 and each may include the ad selection and insertion application 120 in addition to playback functionality.

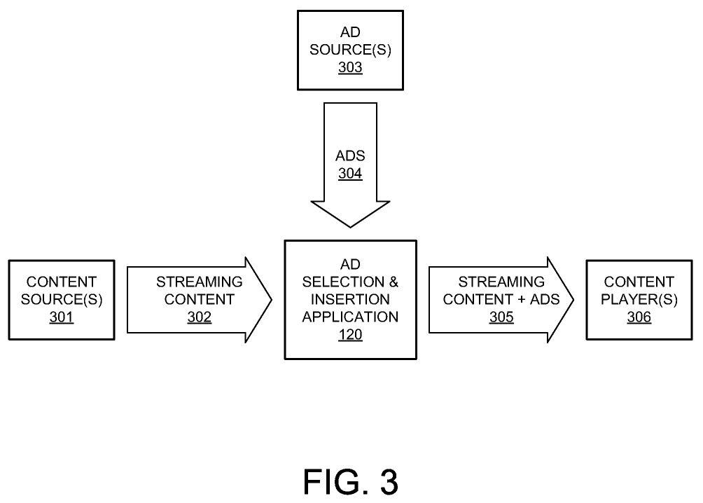

FIG. 3 depicts inputs and outputs of the ad selection and insertion application 120 according to one or more embodiments. The ad selection and insertion application 120 receives streaming content 302 from one or more content sources 301. The streaming content 302 may be received on a scheduled basis, as with cable television or radio programming, or received on an on-demand basis, as with CDs, DVDs, on-demand cable programming or Internet multimedia. The content sources 301 may include television networks, radio networks, satellite networks, websites, DVDs, CDs, hard drives, and other sources of streaming video and audio. The ad selection and insertion application 120 also receives ads 304 from one or more ad sources 303. The ads 304 may be in the form of video advertisements, audio advertisements, interstitial and overlay advertisements, program sponsor spots, product placements, and other forms of advertising. The ad sources 303 may include advertisers, television networks, radio networks, satellite networks, websites, ad service providers, and other sources of advertising content.

The ad selection and insertion application 120 may utilize information about the content and the ads to select and incorporate the ads 304 into the streaming content 302, as will be discussed further below. Incorporation of the ads 304 into the streaming content 302 may include inserting commercials, incorporating interstitial or overlay ads, incorporating a program sponsor spot, or even incorporating a product placement into the audio or video content. The resulting combined streaming content and ads 305 are then sent for delivery to one or more content players 306.

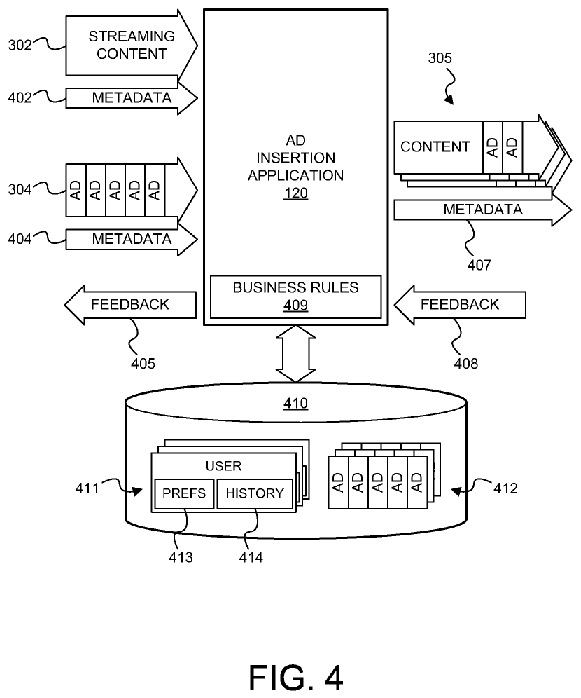

FIG. 4 depicts operation of the ad selection and insertion application 120 according to one or more embodiments. As described above, the ad selection and insertion application 120 receives the streaming content 302 and the ads 304 and incorporates a selection of the ads 304 into the streaming content 302. The selection of the ads 304 to incorporate into the streaming content 302 may require additional information in the form of content metadata 402. Information about the streaming content 302 may be received in the form of the content metadata 402. The content metadata 402 may arrive contemporaneously with the streaming content 302 or it may arrive separately via, for example, the Internet or via another data path. The content metadata 402 may be received by the ad selection and insertion application 120 as extensible markup language (XML) tags, electronic program guide information, or in other formats. The content metadata 402 may include information about the streaming content 302 including, but not limited to, title, episode, credits, actors, actresses, available ad spots, genres, demographic preferences, links to websites, transcripts/scripts, music information, and other data about the streaming content 302.

Information about the ads 304 may be received in the form of ad metadata 404. As with the content metadata 402, the ad metadata 404 may arrive accompanying the ads 304, or separately. The ad metadata 404 may be in the form of XML tags, or other computer-usable formats. The ad metadata 404 may include information about the ads 304 including, but not limited to, company, product or service, links to more information, episode, credits, actors, actresses, genres, targeted demographics, scripts, music information, logos and graphics, geographic limitations, expiration dates, and other data about the ads 304. The arriving ads 304 are stored in a database 410, which may be a file system, an object database, or other media storage facility. The ad metadata 404 may be stored together with the ads 304, as stored ads 412, in the database 410, or the ad metadata 404 and the ads 304 may be stored separately in the database 410. The stored ads 412 may be utilized by the ad selection and insertion application 120 when selecting ads for incorporation into the streaming content 302.

The ad selection and insertion application 120 may utilize only the content metadata 402 and the ad metadata 404 when selecting ads. Based on the user 206 selecting a particular program, the ad selection and insertion application 120 personalizes the selected ad to the user by matching the content metadata 402 associated with the particular program selected by the user 206 to the ad metadata 404. For example, the ad selection and insertion application 120 may select stored ads 412 from the database 410 based on the demographic preferences for a particular program as reported by the content metadata 402. The preferences may be matched to targeted demographics for a particular ad 304. For example, if a selected program 302 is oriented towards women over the age of 40, as set forth by the content metadata 402 associated with the particular program, then the ads dynamically selected by ad selection and insertion application 120 may be ads targeted at women over the age of 40.

The ad selection and insertion application 120 may utilize additional information when selecting ads. Additional information may take the form of stored user information 411. The user information 411 may be singularly stored for an entire household, or it may be stored for individual users. In embodiments where the user information 411 is stored for individual users, the users may be identified when watching or listening to a program. This identification may be an inference based on the programs being watched, or based on an authentication, such as an identifying code entered when a content player 306 is powered on, for example. Identification may also be based on a finger print or other identifying method involving the remote 207.

The stored user information 411 may include a set of user preferences 413, or information specific to the user 206. The user preferences 413 may include user age, gender, income, religious faith, preferred genres, preferred actors, disfavored genres and actors, credit card information for purchases, music preferences, and other self-identified information. The user preferences 413 may be provided manually by the user 206 through an interface separate from or associated with the ad selection and insertion application 120 and/or by inferences on the part of ad selection and insertion application based on previously viewed or heard streaming content 302 associated with the user 206 as well as other information associated with the user and accessible by the ad selection and insertion application.

The user preferences 413 may also include information about a class of service associated with a user 206. Class of service includes the level of service provided by ad selection and insertion application 120 and/or by ad selection and insertion system 200 to the user 206. Class of service may include low, normal, and high levels, such that a user is provided alternate options and benefits based on the class of service selected, as will be discussed further below.

The user information 411 may also include a user history 414, or log, of the ads 304 and/or streaming content 302 viewed or heard by a user or group of users. User information 411 may also include previous user feedback 408 about ads 304 and/or streaming content 302 viewed or heard. For example, the remote 207 may include rating buttons, giving the user 206 an opportunity to rate streaming content 302 or ads 304 dynamically. The user information 411 may be utilized by the ad selection and insertion application 120 in conjunction with the content metadata 402 and ad metadata 404 to further personalize ad selection. For example, the demographic profile of the user 206 stored in the user preferences 413 may supersede the targeted demographic of the currently selected streaming content 302. In this case, the ad selection and insertion application 120 may select ads 304 using the self-identified user information 411 instead of the demographic preferences information in the content metadata 402. Alternatively, when the user information 411 and the content metadata 402 do not identify the same demographic, this may be used to further pinpoint demographics and ads 304. For example, men over 40 who regularly watch and/or listen to streaming content 302typically preferred by teenage boys may be particularly well-suited to a particular set of ads 304.

The ad selection and insertion application 120 may use a set of business rules 409 to make ad selections that a user might prefer. The business rules 409 may include rules covering the use of the user preferences 413 and the user history 414 when selecting ads 304. The business rules 409 may also be utilized to ensure that selected ads 304 are geographically appropriate and that ads have not expired, for example, an ad for an event is not selected past the date of the event. The business rules 409 may also utilize a user's class of service in conjunction with the content metadata 402 to decide how many ads per program are selected. The business rules 409 may also be utilized to aid in selecting ads 304 based at least in part on the content metadata 402, ad metadata 404 and the user information 411. The business rules 409 may be provided by an ad service provider, stored in the database 410, and may also be updated periodically by the ad service provider.

Once a set of ads from the collection of stored ads 412 has been selected for a current streaming content, such as streaming content 302, the ads 304 are incorporated into the streaming content 302 appropriately to form the combined streaming content and ads 305. For video content, commercials may be incorporated by interrupting a program and inserting video clips of commercials. Interstitial ads may be incorporated directly into the streaming content 302, for example, an ad 304 for an upcoming program 302 appearing in a corner of the screen in the midst of the streaming content. Product placements may be intelligently integrated into the streaming content 302, such as replacing an image on a cereal box appearing in the current program. Similar methods may be used to incorporate ads into audio content. Additional information regarding the incorporation of ads is provided below.

Once incorporated, the combined streaming content and ads 305 are delivered as one or more content streams to the content players 306. Accompanying the combined streaming content and ads 305 may be combined metadata 407. The combined metadata 407 may be composed of a combination of the content metadata 402 and ad metadata 404 previously received. The combined metadata 407 may include information about links to websites, product purchase information, actors, transcripts, and other information associated with the combined streaming content and ads 305. It should be noted that the ad selection and insertion application 120 may only select and incorporate the stored ads 412 at the time that a program 302 is selected for playing. This helps ensure that the selected ads 412 are most appropriate for the date of viewing and for the current user 206. It should also be noted that the user 206 may be prevented from fast forwarding through or otherwise avoiding ads 412, although ad avoidance may be enabled for higher classes of service.

The ad selection and insertion application 120 may utilize the feedback 408 received from the user 206, in addition to the application's own selections to generate feedback 405 for an ad service provider. In this fashion, the ad service provider can receive information via network 130 about selected ads, as well as information about whether or not a user 206 liked an ad or purchased a product as a result of an ad, for example. An advertiser may only need to pay for users who actually view a particular ad using ad selection and insertion system 200. Feedback 405 may also be utilized to request that a different mix of ads 304 be delivered, for example, or otherwise may enable two-way communication between the ad selection and insertion application 120 and the ad service provider.

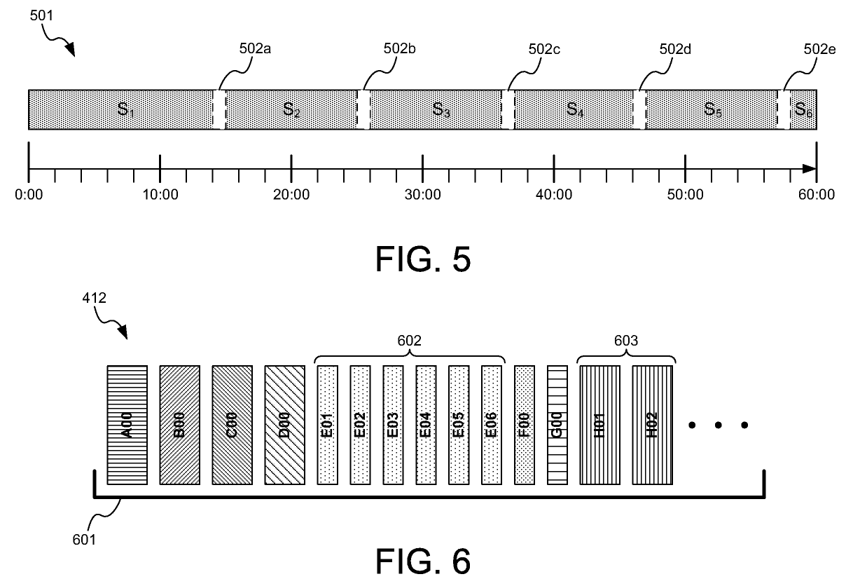

FIGS. 5 and 6 will now be described. FIG. 5 in particular depicts a program timeline 501 for a particular program of the streaming content 302 according to one or more embodiments. The program timeline 501 may be for an hour-long drama, for example. The content metadata 402 associated with the streaming content 302 may provide information about the length of the program and times for potential ad slots. The program timeline 501 may be divided into a series of segments S₁, S₂, S₃, S₄, S₅, and S₆, divided up by a series of ad slots 502a, 502b, 502c, 502d, 502e, here totaling 5 minutes of normal ad space for a 60 minute program. Ad slots 502a, 502b, 502c, 502d, 502e may come pre-filled with particular ads already in place. This may ensure that legacy users who are not equipped with a device including the ad selection and insertion application 120 continue to receive ads.

FIG. 6 depicts an ad tray 601 including the stored ads 412 according to one or more embodiments. The stored ads 412 in the ad tray 601 may include ad series 602, 603, or ads which have a continuing story line or other related content and should be viewed in a particular sequence. The ad tray 601 may be used by the ad selection and insertion application 120 to prioritize the stored ads 412 based on their qualifying under the business rules 409. The ad selection and insertion application 120 may then select ads based on additional considerations, including ad length and ad series, for example.

The stored ads 412 in the ad tray 601 may also include a fixed-time ad D00, for example. The fixed-time ad D00 may have been purchased by a particular advertiser for playback at a set time, or within a particular window of time. The purchase of the fixed-time ad D00 may be for all users, or only for certain targeted users. If the fixed-time ad D00 is set for playback, and the user is viewing or listening to a content stream during the set time, then the fixed-time ad D00 is selected for playback at that time, or within the particular window of time. In this fashion, all users or all targeted users that are currently playing a content stream will see the fixed-time ad D00 at almost the same time. An advertiser may use the fixed-time ad D00 to, for example, make a simultaneous announcement to all users at the same or almost the same time.

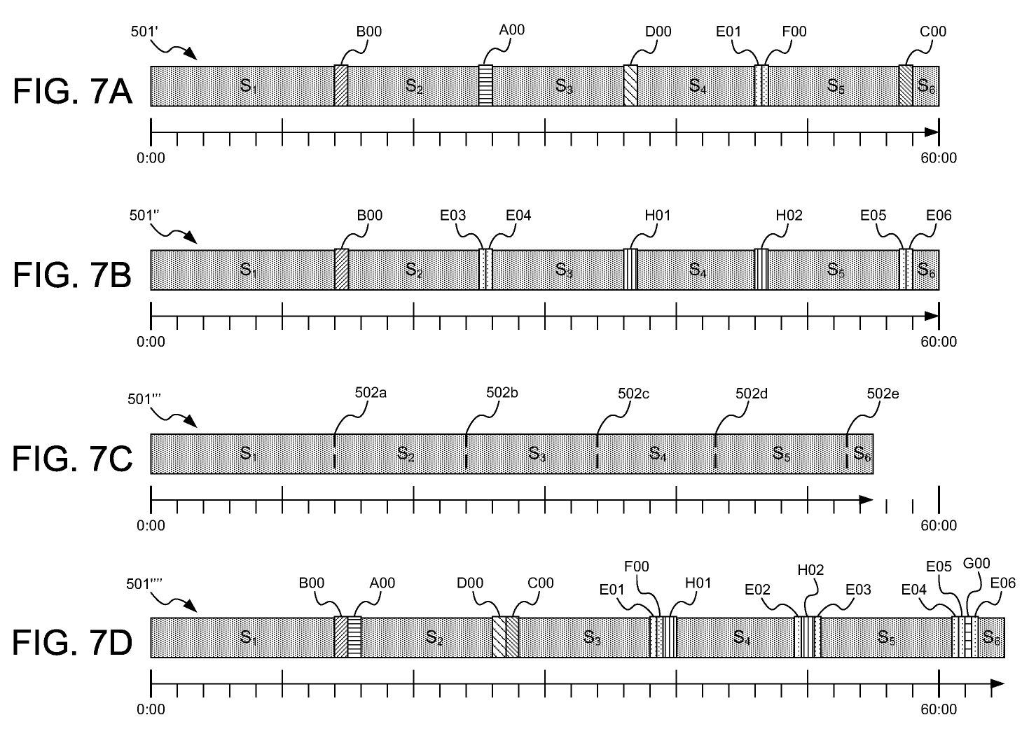

FIGS. 7A-7D depict program timelines after the ads 304 have been selected and incorporated into the program 302 according to one or more embodiments. FIG. 7A depicts a timeline 501′, which may reflect a first series of ad selections for the user 206. The selected ads include several 2-minute ads B00, A00, D00, and C00 and a couple of 1-minute ads E01 and F00. These ads may have been selected based on the content metadata 402 associated with the program, the ad metadata 404 associated with the selected ads, the user information 411, as well as the current time and location, among other considerations. For example, the ad B00 may have been selected based primarily on the ad metadata 404 or the content metadata 402. The ad metadata 404, for example, may signal a contract stating that the ad B00 is to be the first ad displayed with this particular program, regardless of time, location, or viewer demographics. The advertiser presenting the ad B00 may, for example, have a contract with the provider of the program guaranteeing this type of ad priority. Advertisers may similarly be able to secure a particular ad for a particular range of time, such that any content player turned on during that range of time will receive that particular ad. Other arrangements between advertisers, ad service providers, and content sources may be possible.

FIG. 7B depicts a program timeline 501″, which may reflect a second series of ad selections for the user 206 or a different user 208 or 211. According to exemplary embodiments, the different users 208, 211 watching the same program may see a completely different set of ads. Moreover, the user 206 may see a completely different set of ads when watching the same program a second time. The ad B00 is again the first ad, in keeping with the ad metadata 404 as discussed above. Subsequent ads include the ads E03, E04, E05, and E06, constituting the whole of ad series 602. The fact that the ad E03 is the first ad of the series 602 displayed means that the ad selection and insertion application 120 examined the user's history 414 and found the episode ads E01 and E02 had already been played. Ads associated with the program timeline 501″ also include ads H01 and H02, which constitute the whole of ad series 603. As the user 206 watches or listens to the program associated with program timeline 501″, information about the ads B00, E03, E04, H01, H02, E05, E06 and the content viewed and the feedback 408 may be stored in the database 410.

FIG. 7C depicts a program timeline 501′″, which reflects no ads for the program. The ad spots 502a, 502b, 502c, 502d, 502e have been removed from the program, causing the program to be 55 minutes in length. Ad removal may require a hard drive or other storage device to buffer streaming content in order to permit the removal of ads, since scheduled programming may arrive at the same time it is being displayed over the course of the full hour. A user may pay more for a higher class of service than the normal class in order to receive streaming content without advertising. Live events, such as sports programming, may not be able to have ads removed in the fashion of the program timeline 501′″. Other methods of ad removal or ad replacement may be used for higher classes of service in the case of live or scheduled events.

At the other end of the service spectrum, FIG. 7D depicts a program timeline 501″″, which reflects an increased number of ads. Again, as with the program timeline 501′″, some form of streaming content buffer may be needed for this example. Here, a user 206 may receive a lower-than-normal class of service which requires that more ads be viewed. Additional ads extend the length of the program to 65 minutes. In return for more ads, the user may get completely free service, free hardware, or other similar inducements.

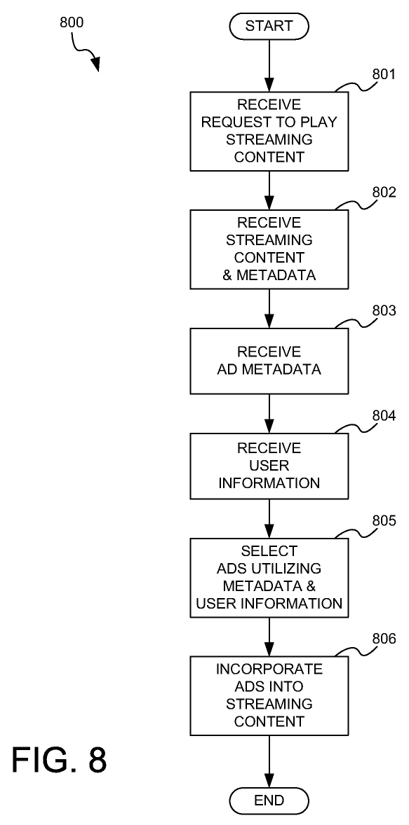

Turning now to FIG. 8, a flowchart depicting a process 800 for selecting personalized ads and incorporating them into the streaming content 302 will be described. The process 800 may be implemented on one or more computing devices, such as computing device 100, and may be used by embodiments of the ad selection and insertion application 120. The logical operations of the various implementations presented, may be (1) a sequence of computer implemented acts or program modules running on one or more computers, such as computing device 100, and/or (2) interconnected machine logic circuits or circuit modules within the computing device 100. The implementation is a matter of choice dependent on the performance requirements of the computing device 100 on which the embodiments are implemented. Accordingly, the functional operations making up the implementations are referred to variously as operations, structural devices, acts, or modules. It will be recognized by one skilled in the art that these operations, structure devices, acts, and modules may be implemented in software, in firmware, in special purpose digital logic, and/or any combination thereof without deviating from the spirit and scope of the attached claims. Moreover, it will be apparent to those skilled in the art that the operations described may be combined, divided, reordered, skipped, and otherwise modified, also without deviating from the spirit and scope of the attached claims.

The process 800 begins with receiving a request for a particular program of the streaming content 302. The request may be made, for example, by the user 206 requesting the program using the remote 207, or it may be a scheduled request, such as when one program follows another program on a schedule. The ad selection and insertion application 120 receives the request at operation 801. The request may or may not include information identifying the user 206. At operation 802, the ad selection and insertion application 120 receives the streaming content 302 from a content source, including from a remote content source such as a cable television channel, a radio station, or IPTV source or from a local content source such as a DVD or hard drive storing the content. The ad selection and insertion application 120 also receives the content metadata 402 associated with the streaming content 302, providing information useful to ad selection. At operation 803, the ad selection and insertion application 120 receives ad metadata 404 from the database 410, an ad source 303, and/or another location. At operation 804, the ad selection and insertion application 120 retrieves information about one or more users of a content player 306. The user information 411 may include the user preferences 413, as well as the histories 414 of streaming content and ads previously seen or heard by the user 206.

At operation 805, the content metadata 402, the ad metadata 404 and the user information 411 are utilized by the ad selection and insertion application 120 to select a personalized subset of ads for insertion into the streaming content 302. This may include examining the content metadata 402 to determine the length and number of ad slots available for the streaming content 402. The number of ad slots may increase or decrease based on the class of service purchased by the user 206, as identified in the user information 411. Once determined, the business rules 409 are utilized to determine which of the available ads should be selected and ordered. The business rules 409 may take as inputs ad contracts, content demographics, user demographics, ad targeting information, user ad viewing history, current time, current location, and other considerations. Selected ads may be prioritized in the ad tray 601 and scheduled for incorporation into the streaming content 302. Episode ads from a series of ads may be checked to be sure that the user 206 has seen all previous episodes of the ad series. At operation 806, the ad selection and insertion application 120 incorporates the selected ads into the streaming content 302, either replacing pre-existing ads, inserted in the designated ad slots 502a, 502b, 502c, 502d, 502e, or otherwise incorporated into the streaming content 302. The resulting modified streaming content 305 is then sent from the ad selection and insertion application 120 for delivery to one or more content players 306.

Although the subject matter presented herein has been described in conjunction with one or more particular embodiments and implementations, it is to be understood that the invention defined in the appended claims is not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for selecting ads for incorporation into a content stream, the method comprising:
receiving the content stream;
receiving content metadata associated with the content stream;
receiving ad metadata associated with each of a plurality of ads; and
selecting a subset of ads from the plurality of ads for incorporation into the content stream utilizing the content metadata and the ad metadata.

2. The method of claim 1, further comprising:
modifying the content stream to incorporate the subset of ads; and
delivering the modified content stream to a user.

3. The method of claim 1, wherein the plurality of ads includes an ad series comprising at least a first ad and a second ad, wherein the first and second ads have related content, and wherein selecting the subset of ads comprises determining whether the first ad of the ad series was previously viewed by a user.

4. The method of claim 3, wherein selecting the subset of ads further comprises selecting only the second ad for the subset of ads when the first ad of the ad series was previously viewed by the user.

5. The method of claim 1, wherein the plurality of ads includes a fixed-time ad comprising an ad to be played at a set time, and wherein selecting the subset of ads comprises selecting the fixed-time ad when the content stream is to be delivered to a user during the set time.

6. The method of claim 1, further comprising receiving user information associated with a user of the content stream, wherein the user information is utilized when selecting the subset of ads for incorporation into the content stream.

7. The method of claim 6, wherein receiving the user information comprises receiving a content history associated with the user.

8. The method of claim 6, wherein receiving the user information comprises receiving an ad history associated with the user.

9. The method of claim 6, wherein receiving the user information comprises receiving a class of service associated with the user, wherein a quantity of ads associated with the subset of ads is adjusted based on the class of service.

10. A system for selecting ads for incorporation into a content stream, the system comprising:
means for receiving the content stream;
means for receiving content metadata associated with the content stream;
means for receiving ad metadata associated with each of a plurality of ads; and
means for selecting a subset of ads from the plurality of ads for incorporation into the content stream based on the content metadata and the ad metadata.

11. The system of claim 10, further comprising:
means for receiving user information associated with a user of the content stream, wherein the user information is utilized when selecting the subset of ads for incorporation into the content stream.

12. The system of claim 11, wherein means for receiving the user information comprises means for receiving a content history associated with the user.

13. The system of claim 11, wherein means for receiving the user information comprises means for receiving an ad history associated with the user.

14. The method of claim 1, wherein the plurality of ads includes a fixed-time ad comprising an ad to be played at a set time, and wherein means for selecting the subset of ads comprises means for selecting the fixed-time ad when the content stream is to be delivered to a user during the set time.

15. The system of claim 10, wherein the plurality of ads includes an ad series comprising at least a first ad and a second ad, wherein the first and second ads have related content, and wherein means for selecting the subset of ads comprises:
means for determining whether the first ad of the ad series was previously viewed by a user, and
means for selecting only the second ad for the subset of ads when the first ad of the ad series was previously viewed by the user.

16. The system of claim 10, further comprising:
means for incorporating the subset of ads into the content stream; and
means for delivering the content stream incorporating the subset of ads for presentation to a user.

17. The system of claim 16, further comprising means for storing an ad identifier associated with the subset of ads in a record associated with the user.

18. A computer-readable medium storing computer-executable instructions which, when executed by a computer, are operative to:
receive a request to view the video program;
receive the video program and information regarding a quantity of ad slots in the video program;
receive ad information associated with a plurality of ads;
receive user information, comprising
a user content viewing history, and
a user ad viewing history;
utilize the ad information, the user content viewing history, the user ad viewing history, a current time, and a current location to select the set of ads to fill the quantity of ad slots.

19. The method of claim 18, wherein the computer-executable instructions are further operative to:
receive further user information comprising a class of service; and
adjust the quantity of ad slots to incorporate into the video program based on the class of service.

20. The method of claim 18, further the computer-executable instructions are further operative to incorporate the set of ads into the video program.
